(19) United States
(12) Patent Application Publication
(10) Pub. No.: US 2012/0199309 A1
(43) Pub. Date: Aug. 9, 2012

(54) SAND ADDITIVES FOR MOLDS/CORES FOR METAL CASTING

(75) Inventors: Ralph E. Showman, Galloway, OH (US); Stacey L. Clifford, Broadview Heights, OH (US); Sean B. Harmon, Columbus, OH (US)

(73) Assignee: ASK CHEMICALS L.P., Wilmington, DE (US)

(21) Appl. No.: 13/020,879

(22) Filed: Feb. 4, 2011

(51) Int. Cl. B22C 9/10; C08K 3/36

(52) U.S. Cl. 164/528; 523/139; 523/142; 523/144

(57) ABSTRACT

A foundry mix composition including silica sand, unexpanded perlite ore, and a binder material. The unexpanded perlite ore is present in the foundry mix composition from about 0.5 wt % to about 5.0 wt %. Exemplary embodiments of the present invention also contemplate methods of making a sand mold/core from such a foundry mix composition.

### TECHNICAL FIELD

Exemplary embodiments of the present invention are directed to sand mold/core compositions. More particularly, exemplary embodiments of the present invention are directed to sand mold/core compositions, such as for the production of molds and cores for use in the metal casting industry, wherein additives are controlled to decrease veining, and to a method of making a sand mold/core comprised of such a composition.

### BACKGROUND

Silica sand is widely used as an aggregate in the metal casting industry for the production of molds and cores. For example, it is used for both “greensand” (sand bonded with water and clay) and for chemically bonded sand. Silica sand may be used with a variety of inorganic and organic chemical binders including, but not limited to, phenolic urethanes, furans, epoxy-acrylics, and ester-cured phenolics.

The chemical binders are mixed with the silica sand and the binder/silica sand mixture is compacted in tooling to take the shape of the desired mold or core. Subsequently, the binder hardens and bonds the silica sand grains together. The mold and core components are then assembled into a mold package and metal is poured into the package and fills the hollow internal cavities in the shape of the desired casting. The heat from the liquid metal starts to decompose the binder and heat the silica sand (especially in the case of ferrous alloys having melting points in excess of 1100° C.). Thermal expansion of the silica sand grains occurs as heat is transferred from the liquid metal to the mold or core components. The thermal expansion of the silica sand grains is relatively linear until the temperature reaches approximately 570° C. at which point the crystal structure of the sand grains transforms. This structural transformation is accompanied by rapid isothermal expansion followed by a period of thermal shrinkage up to around 980° C. when the silica sand grains undergo another crystal structure change accompanied by additional thermal expansion.

It is believed that these rapid volumetric changes in the silica sand grains develop mechanical stresses in the layers of silica sand near the casting surface that can lead to cracking of the mold or core surface in contact with the hot molten liquid metal in the mold. Consequently, the molten liquid metal can flow into these cracks and form undesirable veins and/or fins on the casting surface. These undesirable veins and fins on the casting surface require time and effort to remove. In applications having small internal cored passageways, such as engine blocks and heads with water jackets, veins can extend across and block the passageway. Moreover, the veins blocking the passageways may be in locations that are difficult to detect and even more difficult to remove.

To overcome the veining tendency of silica sand, additives have been used. Current silica sand additives fall within one of three categories based on the mechanism of activity: low expansion aggregates; organic cushioning materials; and fluxes.

Low expansion aggregates are made of silica sand and additives having a lower expansion value than the silica sand. Typical mixtures include silica sand and more than 10 wt % of a low expansion additive. The low expansion additives may be selected from zircon, ceramic beads, aluminum-silicate microspheres, fused silica, and other natural and man-made low expansion additives.

Organic cushioning materials such as wood flour, dextrin, and starch may be mixed with the silica sand to occupy some volume between the silica sand grains. When molten metal is poured into the mold, the heat from the molten metal quickly burns out the organic cushioning material. The volume previously occupied by the organic cushioning material provides a “cushion” or space for the expansion of the silica sand, thus reducing the stresses in the silica sand and resulting in decreased veining.

Fluxes that react with the surface of the silica sand grains to chemically alter the surface layer and the expansion characteristics of the silica sand grains may be added to reduce veining and fins on the casting surface. Examples of such fluxes are iron oxide (FeO), hematite (Fe₂O₃), magnetite (Fe₃O₄), titanium oxide (TiO₂), and Lithia (Li₂O) containing materials such as spodumene.

Although the above mentioned additives can reduce veining during casting, each type of additive has some important disadvantages. The low expansion aggregates tend to be expensive compared to silica sand and need to be used at relatively high levels (greater than 10 wt % based on the total silica sand present). The organic cushioning materials tend to add to the total amount of gas produced by the mold or core when exposed to liquid metal and can significantly reduce mold/core strength when used at levels above 1% of the total sand present. The flux-type additives, which are currently the most widely used additives, also have several drawbacks. For example, iron oxides, when used above about 2% of the total silica sand present can cause increased metal penetration and can reduce mold/core strength when used at higher percentages. The Lithia containing spodumenes are expensive and are typically used in higher percentages, e.g., 4-8% of the total silica sand present.

In still other methods currently employed to reduce veining and fins on the casting surface, the molds/cores are made with naturally occurring zircon, chromite, olivine, and man-made ceramics and other aggregates rather than silica sand. These replacement materials have lower expansion rates with no phase changes and reduce the tendency to form veining defects; however, they are expensive as compared to silica sand.

Consequently, it can be understood that there is a need for silica sand based mixture having a decreased veining tendency, that are inexpensive to produce, and have sufficient strength to withstand the pressures associated with the casting process. Exemplary sand compositions of the present invention satisfy these needs/preferences.

### SUMMARY OF THE GENERAL INVENTIVE CONCEPT

Exemplary embodiments of the present invention are directed to foundry mix compositions that produce exemplary sand molds/cores that exhibit a decreased veining tendency. Exemplary embodiments of such foundry mix compositions and the exemplary sand molds/cores made therefrom are also inexpensive and exhibit sufficient strength for mold/core handling and assembly and are able to withstand the temperature and pressures of associated casting processes.

Exemplary embodiments of foundry mix compositions of the present invention include both an exemplary aggregate and binder material. As would be well known to one of ordinary skill in the art, a selected binder material may be intermixed with the exemplary aggregate, thereby facilitating the binding together thereof.

The exemplary aggregate of the present invention may include a mixture of silica sand and ground unexpanded perlite ore. Unexpanded perlite is a naturally occurring siliceous volcanic rock with a glassy structure similar to obsidian. Analysis of unexpanded perlite indicates it is made of 70-75% SiO₂, 12-15% Al₂O₃, 3-4% Na₂O, 3-5% K₂O, 0.5-2% Fe₂O₃, and lesser amounts of MgO and CaO. In addition, unexpanded perlite also includes about 2% to about 6% water. When unexpanded perlite ore is heated rapidly, the volcanic glass softens and expands from the generation of gas pressure from the moisture converting to steam. Expansion is on the order of four to twenty times depending on the composition of the unexpanded perlite ore, the temperature, and the heating rate. Unexpanded perlite is mined in a number of locations in the US including Oregon, California, Arizona, Texas and others. A number of grades of unexpanded perlite ore are available and are classified by particle size with sizes ranging from about 20 to about 200 mesh.

As a result of the exemplary aggregate, exemplary sand molds/cores made from the exemplary foundry mix compositions of the present invention exhibit a novel veining prevention mechanism that is different from any other additives currently employed in the casting industry. As the unexpanded perlite is rapidly heated into the range of 850°-900° C., it begins to soften and the gas pressure created by the contained water causes rapid expansion. This rapid expansion offsets the contraction of the silica sand grains in the exemplary aggregate that occurs in the same temperature region. It is theorized that the cracking of a mold/core to create veining defects is not caused by the isothermal expansion related to the phase change; but rather by the subsequent contraction. The expansion of the unexpanded perlite is much larger than the contraction of the silica sand, so only a small amount of unexpanded perlite is needed to effectively control veining. At elevated temperatures above the unexpanded perlite expansion range of 850°-900° C., the perlite softens and becomes glassy; providing an additional anti-veining benefit. It should also be understood that materials other than unexpanded perlite that undergo thermal expansion from about 600° C. to about 1000° C. may be used in the embodiments described below.

It was unexpected that a material that expands would control the defect since all other additives currently in use to eliminate veining are designed to control expansion rather than cause more expansion. The term “expansion defects”, as used in the casting industry, is representative of the widely held belief by those having skill in the art that it is the isothermal expansion of the sand that is responsible for the defects and that rapid or non-uniform expansion is not desirable. There are also numerous warnings in the literature against perlite “contamination” into mold/core sand. Although perlite is commonly used in the metal casting industry, it is used as a slag coagulant rather than an additive to silica sand. Granular unexpanded perlite ore is added to the surface of liquid metal in the ladle or furnace. The granular unexpanded perlite undergoes rapid expansion from the heat of the metal. This expansion traps slag and oxides on the surface of the metal and facilitates their removal and prevents their entry into the casting with the flow of metal as the mold is poured. If the unexpanded perlite granules are mixed with mold or core sand and the granules are present on the mold/core surface, the heat from the liquid metal results in expansion that may extend into the mold cavity and creates a corresponding cavity on the surface of the casting. To control the problem of cavity formation, the unexpanded perlite used in the exemplary foundry mix compositions of the present invention have a small grain size, are used in small amounts and are intermixed with silica sand within the exemplary aggregate.

The mechanism of veining control was further explored by slowly heating the unexpanded perlite ore into the normal expansion range. By slowly heating the unexpanded perlite, the trapped moisture responsible for expansion is driven off with only a small volumetric expansion. This resulted in a weight loss of about 3% corresponding to the moisture content of the unexpanded perlite ore. When this expanded perlite ore was used as a sand additive, no improvement was seen in the veining of the sand. It is the expansion of the unexpanded perlite ore rather than fluxing or other mechanisms that produce the anti-veining effects.

Therefore, the exemplary foundry mix compositions described herein may be used to produce exemplary sand molds/cores having decreased veining tendency as compared to current silica sand based sand molds and cores. Moreover, the addition of the fine granular unexpanded perlite to the exemplary aggregate has minimal effect on the strength of the exemplary sand molds/cores.

### BRIEF DESCRIPTION OF THE DRAWING(S)

In addition to the features mentioned above, other aspects of the present invention will be readily apparent from the following descriptions of the drawings and exemplary embodiments, where in like reference numerals across the several views refer to identical or equivalent features, and wherein:

FIG. 1 is a top perspective view of an exemplary sand mold used to produce castings to evaluate the veining characteristics of the cores produced by the exemplary foundry composition of the present invention;

FIG. 2 is a top perspective view of the casting used to evaluate the veining characteristics of the cores produced by the exemplary foundry mix composition;

FIG. 3 is a close-up side view of a casting cavity produced from an sand core made using a traditional silica sand composition; and

FIG. 4 is a close-up side view of a casting cavity produced from an exemplary sand core made using the exemplary foundry mix composition of the present invention.

### DETAILED DESCRIPTION OF EXEMPLARY EMBODIMENT(S)

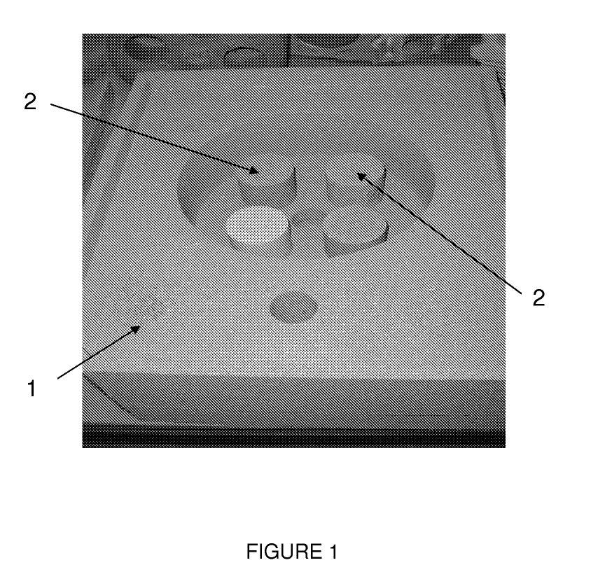

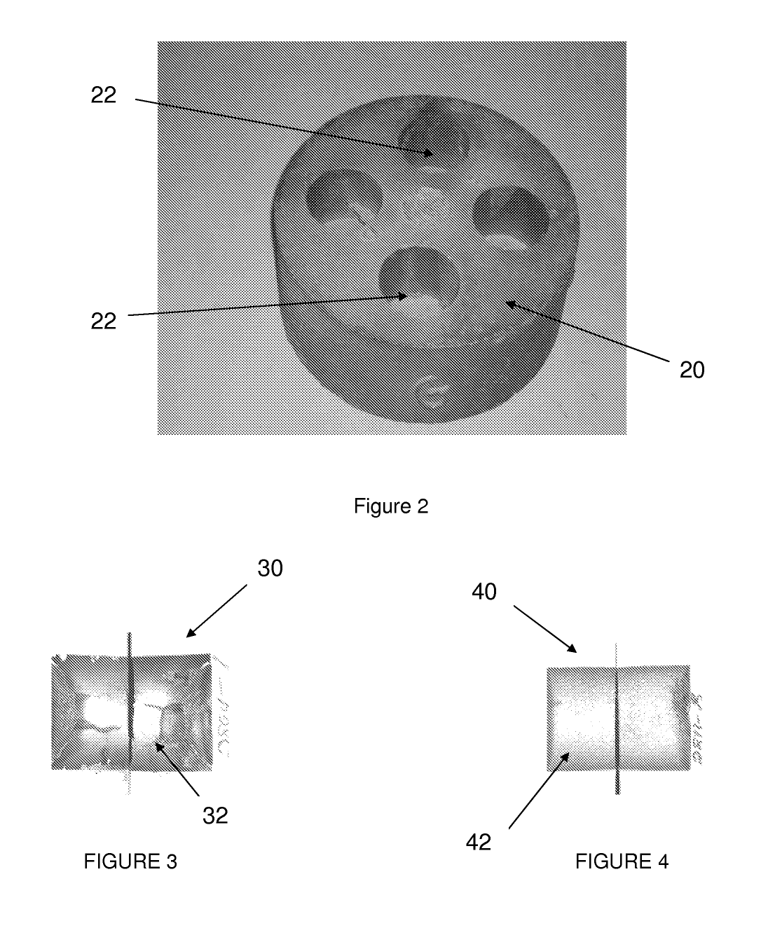

Exemplary embodiments of improved foundry mix compositions according to the present invention are described below. As will be clarified hereinafter, exemplary embodiments of the sand molds/cores made from the exemplary foundry mix compositions of the present invention may exhibit a decreased veining tendency in comparison to known silica sand compositions while maintaining sufficient strength for handling, assembly and the casting process. As shown in FIG. 1, an exemplary sand mold 1 may be formed from the exemplary foundry mix composition of the present invention. Additionally, exemplary sand cores 2 formed from the exemplary foundry mix composition may be glued into the exemplary sand mold 1. FIG. 2 illustrates a casting 20 formed using the exemplary sand mold 1 and exemplary sand cores 2 shown in FIG. 2. The casting 20 has cavities 22 created by the sand cores 2. As will be shown herein, the cavities 22 may be evaluated to determine the veining characteristics of the exemplary sand cores 2. In the testing process the sand cores 2 may be comprised of exemplary foundry mix compositions of the present invention and a traditional silica sand composition for comparison. Although FIG. 1 represents a shape that may be formed using the exemplary foundry mix composition of the present invention, one of ordinary skill would understand that the exemplary foundry mix compositions of the present invention may be used to form an exemplary sand molds/cores 1 having a variety of shapes and having small internal passageways for casted products such as engine blocks and heads with water jackets.

The exemplary aggregate compositions according to the present invention include silica sand and unexpanded ground perlite ore. In one exemplary aggregate according to the present invention, unexpanded perlite ore comprises at least about 0.5 wt %. (As used herein weight percent is based on the amount of silica sand unless otherwise stated.) In another exemplary aggregate, unexpanded perlite ore comprises up to about 10 wt %. In additional exemplary aggregates, unexpanded perlite ore comprises about 0.5 wt % up to about 10 wt %. In other exemplary aggregates, unexpanded perlite ore comprises up to about 5 wt % based on the silica sand present in the exemplary aggregate. In another exemplary aggregate, unexpanded perlite ore comprises about 0.5 wt % to about 5 wt %. More preferably, the unexpanded perlite ore content of the exemplary aggregate comprises up to about 3 wt %. In still other exemplary aggregates, the unexpanded perlite ore comprises about 1 wt % up to about 3 wt %. In the exemplary aggregates, the unexpanded perlite may have a grain size down to about 200 mesh.

Additional additives may also be added to the above exemplary aggregates to form still other exemplary aggregates. These additional additives may include, but are not limited to: iron oxides, alkali earth salts including carbonates and sulfates, organic acid salts, and Lithia bearing compounds like spodumene. In these exemplary aggregates, the additional additives comprise up to about 2 wt %. More specifically, the additional additive content of the exemplary aggregate comprises about 0.5 wt % to about 2 wt %.

Exemplary foundry mix compositions according to the present invention include the exemplary sand aggregate, as described above, and a binding material. The exemplary foundry mix compositions of the present invention may be used to form exemplary sand molds/cores exhibiting a decreased veining tendency. Exemplary foundry mix compositions may include any inorganic or organic warm-box, hot-box, no-bake, or cold-box binder that will sufficiently hold the exemplary sand molds/cores shape together and polymerize in the presence of a curing catalyst. Examples of such binders, include, but are not limited to: phenolic resins; phenolic urethane binders; furan binders; alkaline phenolic binders; epoxy-acrylic binders; and other similar suitable binders. As would be well known to one of skill in the art, additional binders suitable to hold the shape and allow for curing of the exemplary sand molds/cores may also be utilized.

Preferably, either phenolic urethane or epoxy-acrylic binders are used. Phenolic urethane binders are described in U.S. Pat. Nos. 3,485,497 and 3,409,579, which are hereby incorporated by reference as if fully rewritten herein. Phenolic urethane binders are based on a two part system, a first part being a phenolic resin component and a second part being a polyisocyanate component. The epoxy-acrylic binders cured with sulfur dioxide in the presence of an oxidizing agent are described in U.S. Pat. No. 4,526,219 which is hereby incorporated by reference as if fully rewritten herein.

In exemplary foundry mix compositions of the present invention, binders comprise about 0.1 wt % to about 5 wt %. Preferably, the amount of binder ranges from about 0.5 wt % to about 5 wt %. More preferably, the binder comprises about 0.5 wt % to about 2 wt %.

As stated above, the exemplary sand molds/cores may be cured by several processes including, but not limited to: the no-bake process; the warm-box process; the hot-box process; and the cold-box process. Curing of exemplary sand molds/cores by the no-bake process takes place by mixing a liquid curing catalyst with the exemplary foundry mix composition (alternatively, the liquid curing catalyst may be mixed with the exemplary aggregate before the addition of the binder), shaping the exemplary foundry mix composition containing the catalyst to form an exemplary sand mold/core, and allowing the exemplary sand mold/core, including the catalyst, to cure at ambient temperature without the addition of heat. The preferred liquid curing catalyst for the no-bake process is a tertiary amine as described in U.S. Pat. No. 3,485,797, which is incorporated by reference as if rewritten herein.

One of ordinary skill in the art understands that the warm-box and hot-box processes are similar to the no-bake process except the tooling and/or the mold/core shape is heated in order to facilitate curing. Specific examples of such liquid curing catalysts for use with the no-bake curing process include, but are not limited to: 4-alkyl pyridines wherein the alkyl group has from one to four carbon atoms, isoquinoline, arylpyridines such as phenyl pyridine, pyridine, acridine, 2-methoxypyridine, pyridazine, 3-chloro pyridine, quinoline, N-methyl imidazole, N-ethyl imidazole, 4,4′-dipyridine, 4-phenylpropylpyridine, 1-methylbenzimidazole, and 1,4-thiazine. One of ordinary skill in the art would have knowledge of the variety of catalysts suitable for use in the no-bake, the hot-box and the warm-box processes. If a furan binder is used in a warm-box, hot-box or a no-bake process, the curing catalyst typically used is an inorganic or organic acid, e.g. strong acids such as toluene sulfonic acid, xylene sulfonic acid, benzene sulfonic acid, HCl, and H₂SO₄. A weak acid such as phosphoric acid can also be used.

Exemplary sand molds/cores are obtained by the cold-box process by blowing or ramming the exemplary foundry mix composition into a pattern and contacting the exemplary foundry mix composition with a vaporous or gaseous catalyst. Various vapors, vapor/gas mixtures, or gases such as tertiary amines, carbon dioxide, methyl formate, and sulfur dioxide can be used depending on the chemical binder chosen. Those skilled in the art will know which gaseous curing agent is appropriate for the selected binder. For example, an amine vapor/gas mixture is used with phenolic-urethane resins. Sulfur dioxide (in conjunction with an oxidizing agent) is used with an epoxy-acrylic resin as described in U.S. Pat. No. 4,526,219 which is hereby incorporated by reference as if fully rewritten herein. Carbon dioxide or methyl esters are used with alkaline phenolic resole resins as described in US. Pat. Nos. 4,985,489 and 4,750,716 which are hereby incorporated by reference as if fully rewritten herein. Carbon dioxide is also used with binders based on silicates as described in U.S. Pat. No. 4,391,642 which is hereby incorporated by reference as if fully rewritten herein.

Preferably, exemplary sand molds/cores are obtained by using the cold-box process wherein the binder is a cold-box phenolic urethane binder cured by passing a tertiary amine gas, such a triethylamine (“TEA”), through the exemplary foundry mix composition in the manner as described in U.S. Pat. No. 3,409,579 hereby incorporated by reference as if fully rewritten herein. Exemplary foundry mix compositions having an epoxy-acrylic binder may be cured with sulfur dioxide in the presence of an oxidizing agent as described in U.S. Pat. No. 4,526,219 hereby incorporated by reference as if fully rewritten herein. It should be known to one of ordinary skill in the art that almost any organic or inorganic binder system may be used with the exemplary embodiments of the present invention.

It should be apparent to those having skill in the art that other additives such as release agents, solvents, bench life extenders, silicone compounds, etc. may be added to the exemplary foundry mix compositions.

### EXAMPLES

As shown below on TABLE 1, experiments were conducted to compare the veining characteristics of exemplary sand cores against the veining characteristics of traditional silica sand cores. As provided in TABLE 1, Example 1 (control core) is a traditional silica sand core having no additional anti-veining additives and Examples 2-7 are exemplary sand cores made in accordance with the present invention, using unexpanded perlite ore in a variety of sizes and from various locations across North America. More specifically, the unexpanded perlite ore in Examples 2 and 3 are from a first supplier, the unexpanded perlite ore in Examples 4 and 5 are from a second supplier, and the unexpanded perlite ore in Examples 6 and 7 are from a third supplier. The test cores (Examples 1-7) were prepared using the cold-box process by mixing Wedron 540 silica sand, available from Wedron Silica Company, Wedron, Ill., with Isocure™ TKW 10/20 phenolic urethane binder at about 1.0 wt % (a two-part phenolic urethane binder commercially available from ASK Chemicals, Dublin, Ohio, wherein the ratio of Part I to Part II is 1:1). To form the test cores the mixtures were blown into a corebox with 2″×2″ cylindrical cavities and cured with TEA catalyst, available from ASK Chemicals, Dublin, Ohio. Additionally, 0.5 wt % of red iron oxide was added to Examples 3, 5, and 7 in accordance with exemplary embodiments of the present invention.

The veining characteristics of the test cores were measured using a “penetration” test casting as shown in FIG. 2 in which the test cores 2 are glued into a mold assembly 1. Molten class 30 grey iron, having a temperature of approximately 1450° C., is then poured into the mold assembly containing the test cores. The penetration tests for veining and mechanical penetration are described by Tordoff and Tenaglia in AFS Transactions, pp. 149-158 (AFS 84th Annual meeting, St. Louis, Mo., Apr. 21-25, 1980). Surface defects were determined by visual observation and the rating is based upon experience and photographs of the test castings.

The test castings are cooled and cleaned by sand blasting and the internal surfaces of the cavity created by the test cores are evaluated and compared visually for veining and rated on a scale of 1 to 5, where 5 represents the worst veining and 1 showing no veining. The results are set forth in TABLE 1 that follows.

TABLE 1
Veining characteristics of test cores, all cores
produced with Wedron 540 silica sand with 1.2 wt
% Isocure ™ TKW 10/20, 50:50 ratio, cured with TEA.

| | | Total amount of | |
|---|---|---|---|
| | | anti-veining | Veining |
| Example | Additive | additive (wt %) | (rating) |
| 1 | None | none | 4.0 |
| 2 | Unexpanded Perlite | 2% | 1.5 |
| 3 | Unexpanded Perlite + red | 2% + 0.5% | 1.0 |
| | iron oxide | | |
| 4 | Unexpanded Perlite | 2% | 2.5 |
| 5 | Unexpanded Perlite + red | 2% + 0.5% | 1.5 |
| | iron oxide | | |
| 6 | Unexpanded Perlite | 2% | 1.5 |
| 7 | Unexpanded Perlite + red | 2% + 0.5% | 1.0 |
| | iron oxide | | |

As shown in TABLE 1, exemplary sand cores containing the exemplary aggregate including unexpanded perlite ore made in accordance with the present invention (Examples 2-7) have a decreased veining tendency as compared to traditional silica sand cores, even at levels as low as 2.0 wt %.

TABLE 2 provides the results of another experiment comparing exemplary sand cores (Examples 2-9), containing unexpanded perlite ore, made in accordance to the present invention with a traditional silica sand core (Example 1). All the unexpanded perlite ore used in these test cores (Examples 2-9) were from the same supplier. The test cores were again prepared using the cold-box process by mixing Wedron 540 silica sand with Isocure™ TKW 10/20 phenolic urethane binder at about 1.2 wt %. As with the first experiment, TEA catalyst was used as the curing agent. Again, 0.5 wt % of red iron oxide was added to the Examples 6-9 in accordance with exemplary embodiments of the present invention.

The second experiment utilized the same testing criteria as the first experiment. The castings are cooled and cleaned by sand blasting and the internal surfaces of the cavity created by the test cores are evaluated and compared visually for veining and rated on a scale of 1 to 5, where 5 represents the worst veining and 1 showing no veining. The comparison results are set forth in TABLE 2 that follows.

TABLE 2
Veining characteristics of test cores, all cores produced
with Wedron 540 silica sand with 1.2 wt % Isocure ™ TKW
10/20, 50:50 ratio, and cured with TEA

| | | Total amount of | |
|---|---|---|---|
| | | anti-veining | Veining |
| Example | Additive | additive (wt %) | (rating) |
| 1 | none | none | 4.0 |
| 2 | 1% Unexpanded | 1% | 2.5 |
| | Perlite | | |
| 3 | 2% Unexpanded | 2% | 2.0 |
| | Perlite | | |
| 4 | 3% Unexpanded | 3% | 1.5 |
| | Perlite | | |
| 5 | 4% Unexpanded | 4% | 1.0 |
| | Perlite | | |
| 6 | 1% Unexpanded | 1.5% | 2.0 |
| | Perlite + 0.5% red | | |
| | iron oxide | | |
| 7 | 2% Unexpanded | 2.5% | 1.0 |
| | Perlite + 0.5% red | | |
| | iron oxide | | |
| 8 | 3% Unexpanded | 3.5% | 1.0 |
| | Perlite + 0.5% red | | |
| | iron oxide | | |
| 9 | 4% Unexpanded | 4.5% | 1.0 |
| | Perlite + 0.5% red | | |
| | iron oxide | | |

As shown below in TABLE 3, a third experiment was conducted to determine the veining characteristics and strength of exemplary sand cores made in accordance with the present invention as compared to traditional silica sand cores.

The test cores, for the third experiment, were prepared by the warm-box process by mixing Wedron 540 silica sand with about 1.3 wt % of Chem-Rez™ 995 binder, available from ASK Chemicals, Dublin, Ohio, and FC521 catalyst, available from ASK Chemicals, Dublin, Ohio, in about 25 wt % based on the amount of binder. Examples 2-5 include unexpanded perlite ore from a single supplier. As with the first and second experiments, 0.5 wt % of red iron oxide was added to Examples 4-5 in accordance with exemplary embodiments of the present invention. The results are set forth in TABLE 3 that follows.

TABLE 3
Veining characteristics of test cores, all cores
produced with Wedron 540 silica sand with 1.3% Chem-
Rez ™ 995 warm-box binder and 25% FC521 catalyst

| | | Total amount | | | |
|---|---|---|---|---|---|
| | | of anti-veining | Vein- | Tensile | Tensile |
| | | additive (wt % | ing | strength | strength |
| Exam- | | based on total | (rat- | after 5 | after 1 |
| ple | Additive | amount of sand) | ing) | minutes | hour |
| 1 | none | none | 4.0 | 481 psi | 504 psi |
| 2 | 1% Unexpanded | 1% | 1.5 | 503 psi | 710 psi |
| | Perlite | | | | |
| 3 | 2% Unexpanded | 2% | 1.0 | 441 psi | 655 psi |
| | Perlite | | | | |
| 4 | 1% Unexpanded | 1.5% | 1.0 | 411 psi | 584 psi |
| | Perlite + 0.5% | | | | |
| | red iron oxide | | | | |
| 5 | 2% Unexpanded | 2.5% | 1.0 | 405 psi | 523 psi |
| | Perlite + 0.5% | | | | |
| | red iron oxide | | | | |

The Experimental data found in TABLES 1-3 clearly indicates that the exemplary sand cores containing unexpanded perlite ore prepared in accordance with the present invention reduced veining in the test castings, even at levels as low as 2.0 wt %. In addition, the tensile strength data found in TABLE 3 shows that the exemplary sand molds/cores (Examples 2-5), including unexpanded perlite, have sufficient strength for mold/core handling and assembly and are capable of withstanding the pressures associated with the casting process.

FIGS. 3 and 4 also illustrate the decreased veining tendency of the exemplary foundry mix composition of the present invention. FIG. 3 is a close-up view of a casting cavity 30 cast using a traditional silica sand mold/core. As can be seen in FIG. 3 the casting cavity 30 has significant veining 32 and has a veining rating of 5. FIG. 4 is a close-up view of a casting cavity 40 cast using an exemplary sand mold/core made from the exemplary foundry mix composition of the present invention. More particularly, the exemplary foundry mix composition used to create the casting cavity 40 was a mixture of silica sand, 4 wt % unexpanded perlite ore, and a binder material. As can be seen in FIG. 4, the surface 42 of the casting cavity 40 is free from veining and other defects and has a veining rating of 1. Thus, a comparison of FIGS. 3 and 4 illustrates the decreased veining tendency of exemplary sand molds/cores made from the exemplary foundry mix composition of the present invention.

In addition to exemplary embodiments wherein the exemplary aggregate is chemically bonded, the exemplary aggregate may also be bonded together, to form an exemplary sand mold/core, with water and clay similar to greensand. Exemplary sand molds/cores made from bonding the exemplary aggregate in this manner also exhibit a decreased veining tendency while maintaining sufficient strength to undergo the molding and casting process.

While certain embodiments of the present invention are described in detail above. The scope of the invention is not to be considered limited by such disclosure, and modifications are possible without departing from the spirit of the invention as evidenced by the following claims:

What is claimed is:

1. A foundry mix composition, comprising:
silica sand;
at least about 0.5 wt % unexpanded perlite; and
a binder material.

2. The foundry mix composition of claim 1, wherein the unexpanded perlite has a size range of between about 20 to about 200 mesh.

3. The foundry mix composition of claim 1, wherein the binder material is selected from a group consisting of phenolic resins, phenolic urethanes, furan binders, alkaline phenolic binders, epoxy-acrylic binders, and other suitable binders.

4. The foundry mix composition of claim 1, further comprising at least about 0.5 wt % additives.

5. The foundry mix composition of claim 4, wherein said additives are selected from a group consisting of iron oxides, alkali earth salts including carbonates and sulfates, organic acid salts, and spodumene.

6. The foundry mix composition of claim 1, further comprising a compound selected from a group consisting of release agents, solvents, bench life extenders, silicone compounds and other similar compounds.

7. The foundry mix composition of claim 1, wherein the unexpanded perlite ore is present in a range from about 0.5 wt % to about 10 wt %.

8. The foundry mix composition of claim 1, wherein the unexpanded perlite ore is present in a range from about 1 wt % to about 3 wt %.

9. A foundry mix composition, comprising:
a first granular material, the first granular material thermally shrinking between the range from about 800° C. to about 980° C.;
a second granular material, the second granular material thermally expanding between the range of about 850° C. to about 900° C.; and
a binder material.

10. A foundry mix composition of claim 9, wherein the first granular material is silica sand.

11. A foundry mix composition of claim 9, wherein the second granular material is unexpanded perlite ore.

12. A foundry mix composition of claim 9, wherein the second granular material is present in a range from about 0.5 wt % to about 10 wt %.

13. A foundry mix composition of claim 9, wherein the second granular material is present in a range from about 1 wt % to about 3 wt %.

14. The foundry mix composition of claim 9, wherein said binder material is present in a range of about 0.5 wt % to about 5 wt %.

15. The foundry mix composition of claim 9, wherein said binder material is selected from a group consisting of phenolic resins, phenolic urethanes, furan binders, alkaline phenolic binders, epoxy-acrylic binders, and other suitable binders.

16. The foundry mix composition of claim 9, wherein said second granular material has a grain size of about 20 to about 200 mesh.

17. The foundry mix composition of claim 9, further comprising a compound selected from a group consisting of release agents, solvents, bench life extenders, silicone compounds and other similar compounds.

18. A method of making a sand mold/core, comprising:
providing silica sand;
adding at least about 0.5 wt % unexpanded perlite and a binder material to said silica sand to form a foundry mix;
molding said foundry mix; and
curing said binder material.

19. The method of claim 18, wherein said unexpanded perlite is present in a range from about 0.5 wt % to about 5 wt %.

20. The method of claim 18, wherein said unexpanded perlite material has a grain size of about 20 to about 200 mesh.
